(19) United States
(12) Patent Application Publication
(10) Pub. No.: US 2017/0245470 A1
(43) Pub. Date: Aug. 31, 2017

(54) PET LEASH

(71) Applicant: Doskocil Manufacturing Company, Arlington, TX (US)

(72) Inventor: Jack RENFORTH, Azle, TX (US)

(21) Appl. No.: 15/053,346

(22) Filed: Feb. 25, 2016

(51) Int. Cl. A01K 27/00

(52) U.S. Cl. CPC A01K 27/003; A01K 27/005

(57) ABSTRACT

A pet leash is basically provided with a grip, an elongated mainline, first and second tethers, a first swivel and a second swivel. The grip is configured to be held by a handler. The elongated mainline has a first mainline end connected to an end of the grip. Each of the first and second tethers has a first tether end and a second tether end. The first tether end is connected to a second mainline end of the mainline. The second tether end is configured to be secured to a collar or a harness. The first swivel is disposed between the grip and the elongated mainline. The first swivel connects the first mainline end to the end of the grip. The second swivel connects the first tether ends of the tethers and the second mainline end.

### BACKGROUND

Field of the Invention

This invention generally relates to a pet leash. More specifically, the present invention relates to a pet leash that is configured to constrain one or more pets.

Background Information

A pet leash can be designed to secure and/constrain one or more pets. A multi-pet pet leash can include multiple tethers that are each configured to be attached to a pet collar or a pet harness. The pet leash can also be configured to include one or more swivels to prevent tangling of the tethers. Additionally, a pet leash can be designed to include reflective portions to serve as an enhanced safety precaution during night walking of the pet(s).

### SUMMARY

Generally, the present disclosure is directed to various features of a pet leash having one or more tethers configured to be attached to a pet collar or a harness.

In one feature, a pet leash is provided comprising a grip, an elongated mainline, a first tether and a second tether, a first swivel and a second swivel. The grip is configured to be held by a handler. The elongated mainline has a first mainline end connected to an end of the grip. Each of the first and second tethers has a first tether end and a second tether end. The first tether end of the first and second tethers is connected to a second mainline end of the mainline. The second tether end of the first and second tethers is configured to be secured to a collar or a harness. The first swivel is disposed between the grip and the elongated mainline. The first swivel connects the first mainline end to the end of the grip. The second swivel connects the first tether ends of the tethers and the second mainline end.

Also other objects, features, aspects and advantages of the disclosed pet leash will become apparent to those skilled in the art from the following detailed description, which, taken in conjunction with the annexed drawings, discloses one embodiment and two modifications of the pet leash.

### BRIEF DESCRIPTION OF THE DRAWINGS

Referring now to the attached drawings which form a part of this original disclosure:

FIG. 1 is a perspective view of a handler that is equipped with a pet leash having two tethers in accordance with one illustrated embodiment;

FIG. 2 is a plan view of the pet leash of FIG. 1;

FIG. 3 is an enlarged view plan of a fastener of a tether of the pet leash of FIG. 2;

FIG. 4 is an enlarged plan view of a first swivel of the pet leash of FIG. 2;

FIG. 5 is an enlarged plan view of a second swivel of the pet leash of FIG. 2;

FIG. 6 is a plan perspective view of a first modified pet leash;

FIG. 7 is a plan perspective view of a second modified pet leash; and

FIG. 8 is a plan perspective view of a third modified pet leash.

### DETAILED DESCRIPTION OF EMBODIMENTS

Selected embodiments will now be explained with reference to the drawings. It will be apparent to those skilled in the pet products field from this disclosure that the following descriptions of the embodiments are provided for illustration only and not for the purpose of limiting the invention as defined by the appended claims and their equivalents.

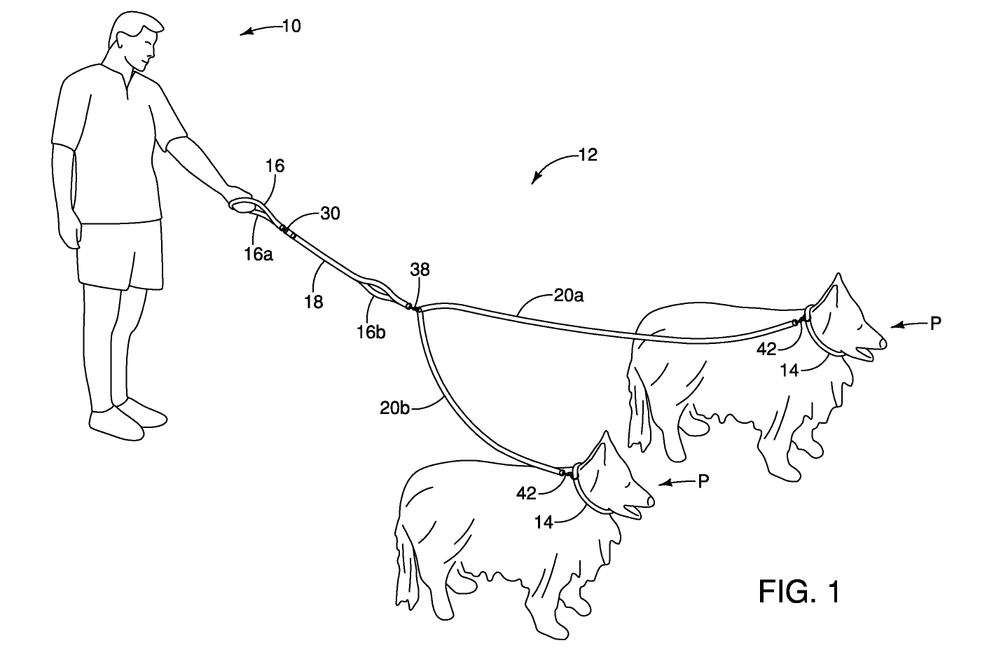

Referring initially to FIG. 1, a handler 10 is illustrated handling a multi-pet pet leash 12 in accordance with a first illustrated embodiment. The pet leash 12 is configured to restrain one or more pets P by fastening the pet leash 12 to an animal harness or collar 14. In the illustrated embodiment, the pet leash 12 comprises a grip 16, an elongated mainline 18, a first tether 20a and a second tether 20b. As the pet leash 12 is designed to constrain one or more pets, the pet leash 12 of the illustrated embodiment has first and second tethers 20a and 20b that are each fastened to the pet collars 14 to restrain the pets P shown. It will be apparent to those skilled in the art that the pet leash 12 can be modified to include just one or additional tethers as needed and/or desired.

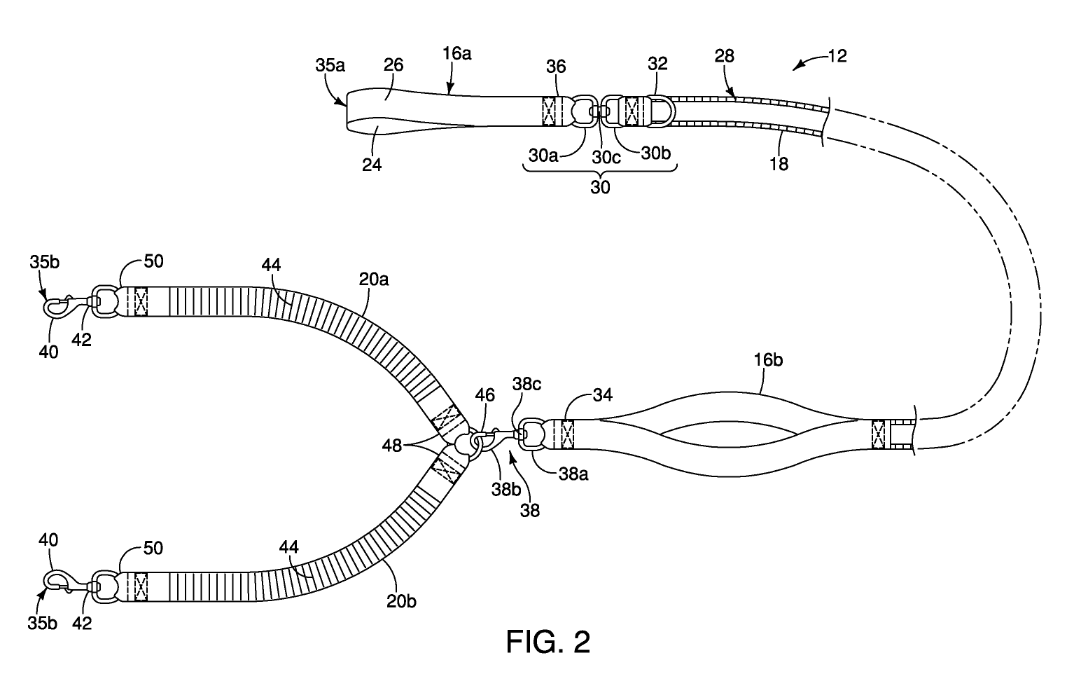

Preferably, the pet leash 12 is constructed of a durable fabric material that would allow the pet leash 12 to remain flexible and easy to maneuver. Thus, the pet leash 12 is constructed of a sturdy and thick fabric material, such as nylon. In the illustrated embodiment, the pet leash 12 is constructed primarily of nylon. It is noted that, at least one of the grip 16, the mainline 18 and the animal first and second tethers 20a and 20b is primarily of nylon. However, preferably, each of these elements is primarily nylon. Also, the pet leash 12 is preferably designed to have distinctive and noticeable patterns made of one or more reflective materials. Specifically, as best seen in FIG. 2, the pet leash 12 of the illustrated embodiment includes reflective nylon that is designed as reflective webbing 28. Thus, at least one of the grip 16, the mainline 18 and the first and second tethers 20a and 20b includes reflective nylon. In this manner, the pet leash 12 can be more noticeable during nighttime use as the reflective webbing 28 is configured to reflect car headlights or any other lights.

The grip 16 of the pet leash 12 will now be discussed with reference to FIG. 2. In the illustrated embodiment as shown, the grip 16 is one of a first grip 16a and a second grip 16b. The first grip 16a is constructed as an enclosed loop that defines a first distal end 35a of the pet leash 12 so that the first grip 16a is configured to be held by the handler 10. The second grip 16b is disposed distal from the first grip 16a and the mainline 18 on the pet leash 12.

The first grip 16a is preferably constructed primarily of nylon and is preferably padded for a more comfortable use. In the illustrated embodiment as shown, at least the first grip 16a of the pet leash 12 is padded. However, it will be apparent to those skilled in the art from this disclosure that the second grip 16b, the mainline 18 and the first and second tethers 20a and 20b may be padded as well, as needed and/or desired. In the illustrated embodiment, the first grip 16a includes an inner padded layer 24 and an outer layer 26 that is a nylon layer. The outer nylon layer 26 is attached to the inner padded layer 24 by stitching and sewing (not shown). It will be apparent to those skilled in the art from this disclosure that the outer nylon layer 26 may also be attached to the inner padded layer 24 by other attachment devices such as adhesives, as needed and/or desired. The outer nylon layer 26 of the first grip 16a can also include reflective nylon and/or reflective webbing 28. As shown, the first grip 16a is attached to the mainline 18 by a first swivel 30 to enable rotational movement of the first grip 16a with respect to the mainline 18.

The mainline 18 of the pet leash 12 will now be discussed. Preferably, the mainline 18 is made primarily out of nylon and includes reflective webbing 28 disposed throughout the majority of the mainline 18. In the illustrated embodiment, the reflective webbing 28 is stitched sections of the mainline 18. It will be apparent to those skilled in the art from this disclosure that the reflective nylon can include other designs or patterns as needed and/or desired.

As shown, the mainline 18 has a first mainline end 32 and a second mainline end 34. The first mainline end 32 is connected to an end 36 of the first grip 16a by the first swivel 30. The second mainline end 34 is attached to each of the first and second tethers 20a and 20b by a second swivel 38. The mainline 18 also includes the second grip 16b that is a loop in the mainline 18. Specifically, in the illustrated embodiment as shown, the second grip 16b is disposed on the mainline 18 of the pet leash 12 in a position that is closer to both the first and second tethers 20a and 20b than the first grip 16a is disposed to the first and second tethers 20a and 20b. In the illustrated embodiment, the second grip 16b includes the second mainline end 34 of the mainline 18. Alternatively, the second grip 16b can also be adjacent to the second mainline end 34. The second grip 16b is disposed on the mainline 18 to enable better control over larger and more unruly pets, and can be useful during the training of pets. In this way, the second grip 16b is configured as a control handle. As previously mentioned, the second grip 16b is padded. Preferably, at least a portion of the second grip 16b is padded to provide a more comfortable grip for the handler 10.

The first and second tethers 20a and 20b will now be discussed. In the illustrated embodiment, the first and second tethers 20a and 20b are identical. Thus, for the sake of brevity, only the first tether 20a will be described herein, and any discussion of the first tether 20a is applicable to the second tether 20b. Also, corresponding components between the first and second tethers 20a and 20b will receive the same reference numeral in the disclosure.

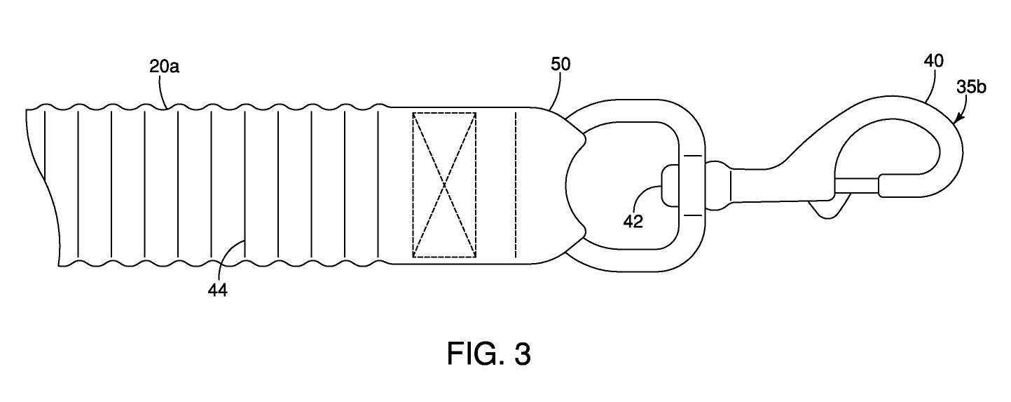

In the illustrated embodiment, first tether 20a of the pet leash 12 has a first tether end 48 and a second tether end 50. The first tether end 48 is connected to the second mainline end 34 of the mainline 18 by the second swivel 38. The second tether end 50 is configured to be secured to the collar 14. Preferably, as best seen in FIG. 3, the second tether end 50 includes a first fastening member 40 that is a snap hook so that the second tether end 50 is detachably connected to the collar 14. The first fastening member includes a third swivel 42 to enable a degree of free movement for the pet P. It will be apparent to those skilled in the art form this disclosure that the first fastening member 40 can also be detachably connected to the second mainline end 34 by being a double ended snap hook.

As shown in the illustrated embodiment, at least one of the first and second tethers 20a and 20b includes an elastic portion 44. Preferably, the majority of each of the first and second tethers 20a and 20b is comprised of the elastic portion 44. Typically, the elastic portion 44 can include an elastic cord (not shown) having one or more elastic strands to form a core that is covered by a layer of woven fabric or polypropylene sheath (not shown). In the illustrated embodiment, the elastic portion 44 includes an outer nylon cover (not shown). The elastic portions 44 of the first and second tethers 20a and 20b are designed to provide a more cushioned walk for the pets P and the handler 10.

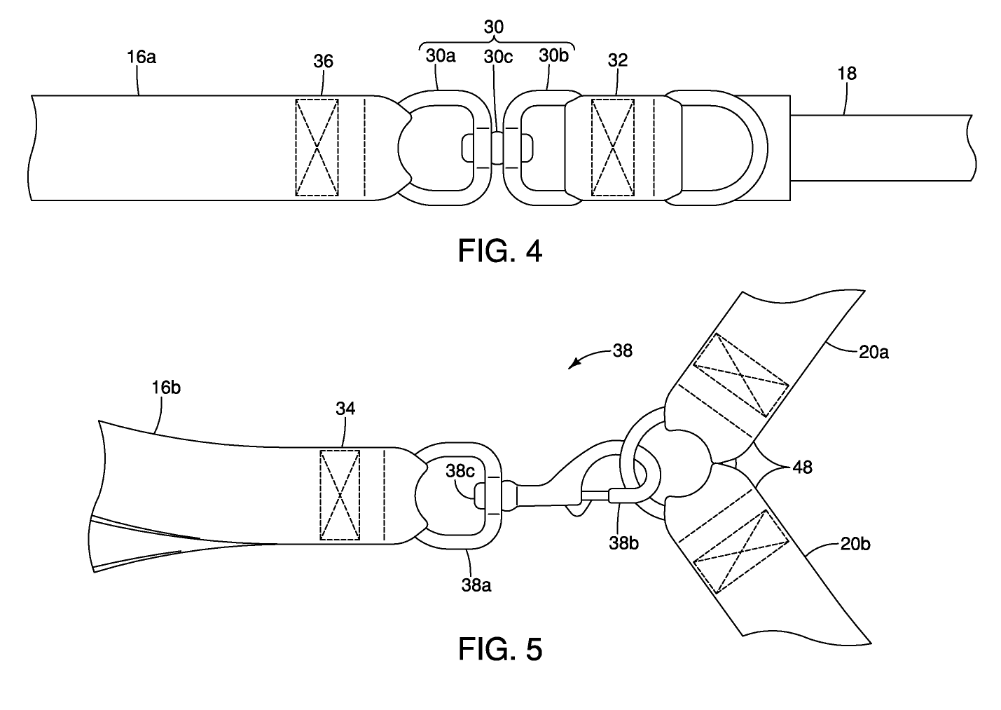

The first swivel 30 of the pet leash 12 will now be discussed with reference to FIG. 4. The first swivel 30 is preferably made of metal or another type of rigid material. The first swivel 30 is positioned and configured to help prevent tangling of the first and second tethers 20a and 20b and/or twisting of the mainline 18 during use of the pet leash 12. As previously stated, the first swivel 30 is disposed between the first grip 16a and the mainline 18 to connect the first mainline end 32 to the end 36 of the first grip 16a. As shown, the first swivel 30 has a first part 30a, a second part 30b and a swivel part 30c. The first part 30a is connected to the end 36 of the first grip 16a. The second part 30b is connected to the first mainline end 32. The swivel part 30c connects the first and second parts 30a and 30b of the first swivel 30. In the illustrated embodiment, the first and second parts 30a and 30b of the first swivel 30 are closed loops. However, it will be apparent to one skilled in the art from this disclosure that at least one of the first and second parts 30a and 30b of the first swivel 30 can be configured as a snap hook so that the first swivel 30 can be detachably connected to the mainline 18 if desired.

The second swivel 38 will now be discussed with reference to FIG. 5. Similar to the first swivel 30, the second swivel 38 is preferably made out of metal or another type of rigid material and is also configured and positioned to prevent tangling of the first and second tethers 20a and 20b and/or twisting of the mainline 18 during use of the pet leash 12. In this way, the second swivel 38 is disposed downstream of the mainline 18 with respect to the first swivel 30 and is positioned closer to the first and second tethers 20a and 20b. The second swivel 38 connects the first tether ends 48 of the first and second tethers 20a and 20b to the second mainline end 34. Similar to the first swivel 30, the second swivel 38 has a first part 38a, a second part 38b and a swivel part 38c. The first part 38a of the second swivel 38 is connected to the second mainline end 34. The second part 38b of the second swivel 38 is connected to the first tether ends 48 of the first and second tethers 20a and 20b. The swivel part 38c of the second swivel 38 connects the first and second parts 38a and 38b. In the illustrated embodiment, as shown, one of the first and second parts 38a and 38b of the second swivel 38 is a loop and the other of the first and second parts 38a and 38b of the second swivel 38 is a snap hook. In the illustrated embodiment, the second part 38b of the second swivel 38 is the snap hook so that the second swivel 38 is detachably connected to the tethers 20. It will be apparent to those skilled in the art from this disclosure that the first part 38a of the second swivel 38 can alternatively be the snap hook, and that the first part 38a of the second swivel 38 can be an additional snap hook.

In the illustrated embodiment, the first and second swivels 30 and 38 differ in that the second swivel 38 includes the snap hook 46 that is a second fastening member. However, it will be apparent to those skilled in the art from this disclosure that there are four possible arrangements of the first and second swivels 30 and 38: 1) both first and second swivels 30 and 38 include the snap hook 46, 2) neither of the first and second swivels 30 and 38 includes the snap hook 46, 3) only the first swivel 30 includes the snap hook 46, 4) only the second swivel includes the snap hook 46. Preferably, at least one of the first and second swivels 30 and 38 includes the snap hook 46. Thus, the snap hook 46 is configured to detachably connect at least one of the first grip 16a to the mainline 18 and the first and second tethers 20a and 20b to the mainline 18. In other words, at least the first grip 16a is detachably connected to the mainline 18, or at least the first and second tethers 20a and 20b are detachably connected to the mainline 18 via the snap hook 46.

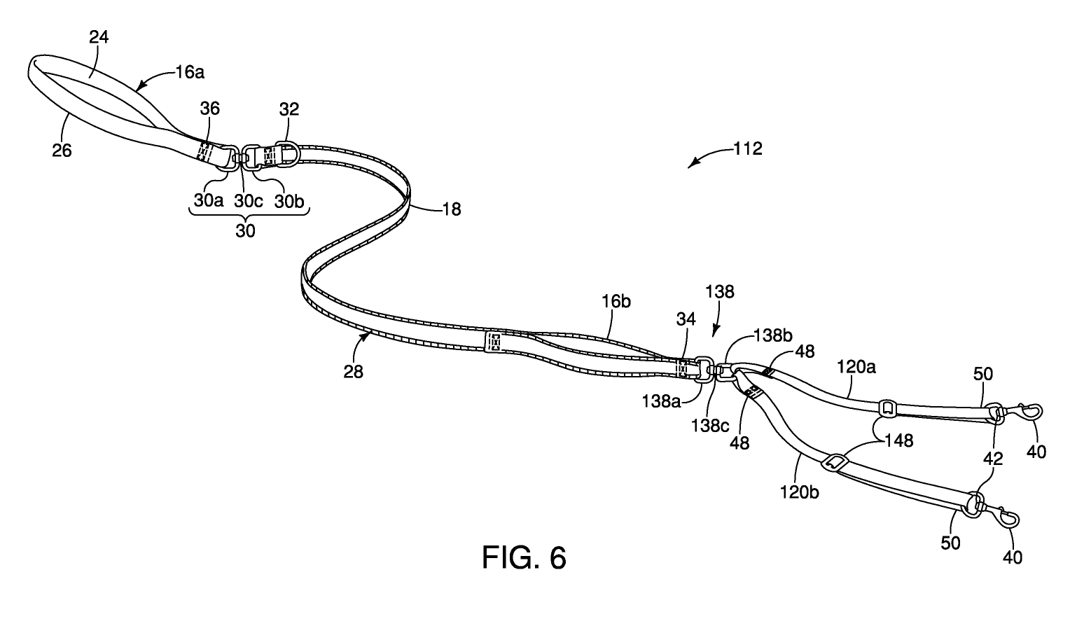

Referring now to FIG. 6, a first modified pet leash 112 will now be discussed. Due to the similarity between the first modified pet leash 112 and the pet leash 12, structures of the modified pet leash 112 having identical corresponding structures in the pet leash 12 will receive the same reference numeral. Any modified structures of the pet leash 112 will receive the same reference numeral as that of the corresponding structures of the pet leash 12 but increased by 100.

Similar to the pet leash 12, the pet leash 112 is constructed to be used to constrain one or more animals. The pet leash 112 is constructed primarily of nylon and preferably includes reflective webbing 28. As shown in the illustrated embodiment, the pet leash 112 includes a first grip 16a, a mainline 18 having a second grip 16b and first and second tethers 120a and 120b. It will be apparent to those skilled in the art from this disclosure that the pet leash 112 can include additional tethers to accommodate additional animals, as needed and/or desired. The pet leash 112 further includes a first swivel 30 and a second swivel 138. The pet leash 112 is identical to the pet leash 12, except the second swivel 38 of the pet leash 12 has been replaced with a modified second swivel 138. The second swivel 138 of the pet leash 12 includes a first part 138a, a second part 138b and a swivel part 138c. The second swivel 138 does not include a snap hook but the first and second parts 138a and 138b of the second swivel 138 are both enclosed loops.

In addition, the first and second tethers 120a and 120b of the pet leash 112 have been modified to not include elastic portions. Instead, the first and second tethers 120a and 120b of the pet leash 112 are constructed primarily of nylon and include adjustable portions 148 so that the lengths of the tethers 120 are adjustable.

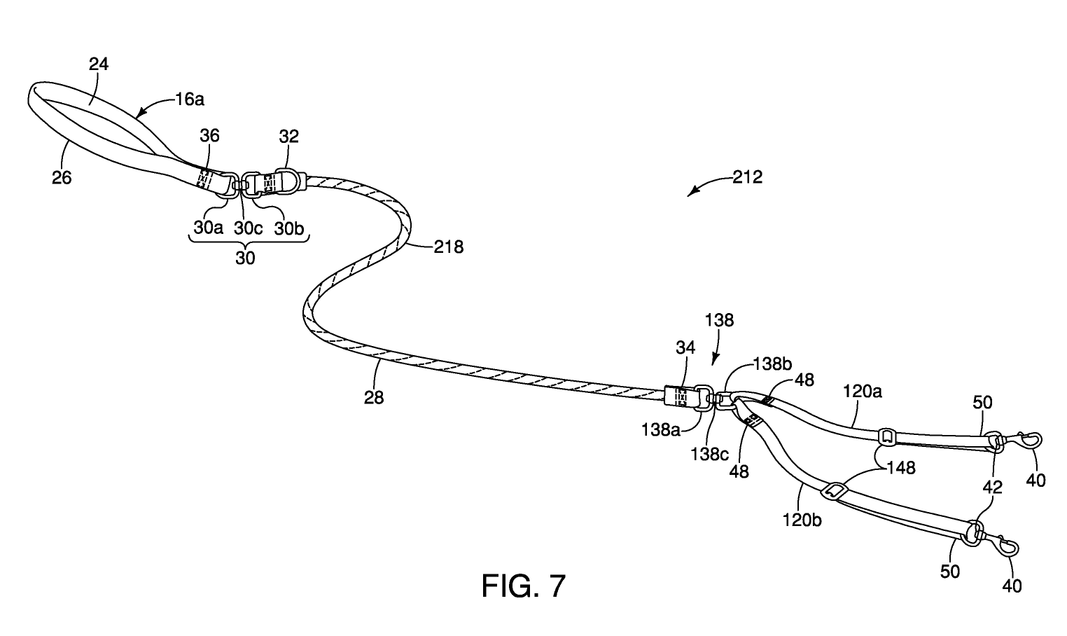

Referring now to FIG. 7, a second modified pet leash 212 will now be discussed. Due to the similarity between the second modified pet leash 212 and the first modified pet leash 112, structures of the pet leash 212 having identical corresponding structures in the pet leash 112 will receive the same reference numeral. Any modified structures of the pet leash 212 will receive the same reference numeral as that of the corresponding structures of the pet leash 112 but increased by 100.

Similar to the pet leash 112, the pet leash 212 is constructed to be used to constrain one or more animals. The pet leash 212 is constructed primarily of nylon and preferably includes reflective webbing 28. As shown in the illustrated embodiment, the pet leash 212 includes a first grip 16a, a mainline 218 and first and second tethers 120a and 120b. It will be apparent to those skilled in the art from this disclosure that the pet leash 212 can include additional tethers to accommodate additional animals, as needed and/or desired. The pet leash 212 further includes a first swivel 30 and a second swivel 38. The second modified pet leash 212 is identical to the first modified pet leash 112 except the mainline 218 has been modified to not include the second grip 16b. Thus, the second modified pet leash 212 provides a simpler configuration of a pet leash.

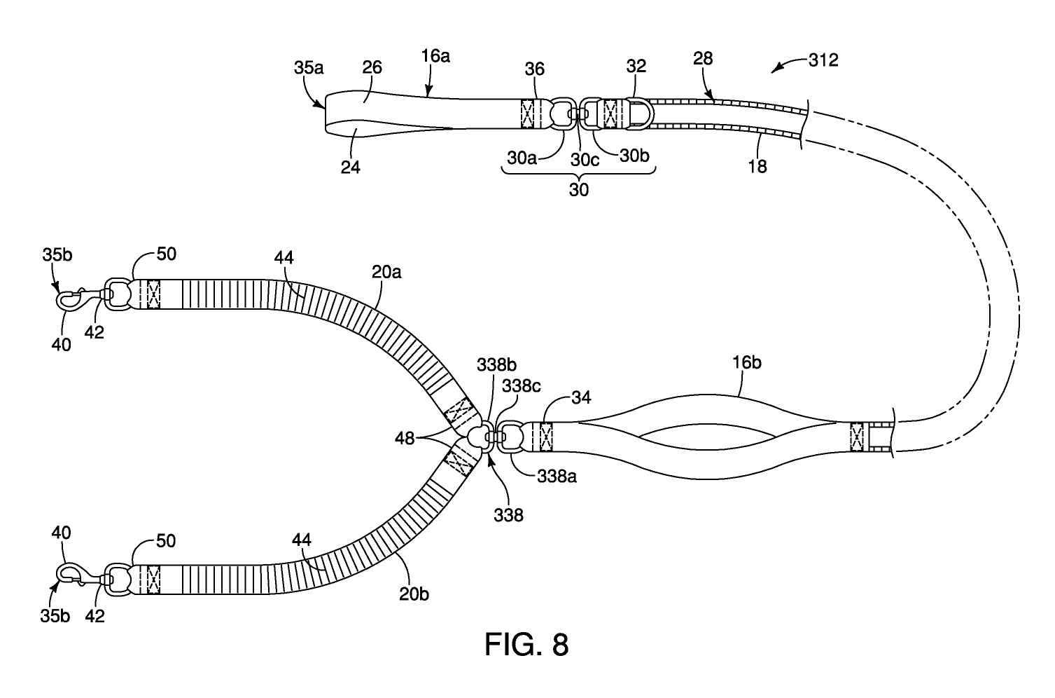

Referring now to FIG. 8, a third modified pet leash 312 is shown. The pet leash 312 is identical to the pet leash 12 of the first illustrated embodiment, except that the second swivel 38 is replaced with a second swivel 338. The second swivel 338 includes a first swivel part 338a, a second part 338b and a swivel part 338c. In the pet leash 312, the second part 338b of the second swivel 338 is an enclosed loop instead of a snap-hook.

In understanding the scope of the present invention, the term “comprising” and its derivatives, as used herein, are intended to be open ended terms that specify the presence of the stated features, elements, components, and/or groups, but do not exclude the presence of other unstated features, elements, components, and/or groups. The foregoing also applies to words having similar meanings such as the terms, “including”, “having” and their derivatives. Also, the terms “part,” “section,” “portion,” “member” or “component” when used in the singular can have the dual meaning of a single part or a plurality of parts unless otherwise stated.

Also it will be understood that although the terms “first” and “second” may be used herein to describe various components these components should not be limited by these terms. These terms are only used to distinguish one component from another. Thus, for example, a first component discussed above could be termed a second component and vice-a-versa without departing from the teachings of the present invention. The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “connected”, “coupled” and their derivatives.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A multi-pet leash comprising:
a grip configured to be held by a handler;
an elongated mainline having a first mainline end configured to be connected to an end of the grip and a second mainline end;
a first tether and a second tether, each of the first and second tethers having a first tether end and a second tether end, the first tether end of the first and second tethers being configured to be connected to the second mainline end of the mainline, the second tether end of the first and second tethers being configured to be secured to a collar or a harness;
a first swivel disposed between the grip and the elongated mainline, the first swivel being configured to connect the first mainline end to the end of the grip; and
a second swivel being configured to connect each of the first tether ends of the first and second tethers and the second mainline end.

2. The multi-pet leash according to claim 1, wherein
at least one of the first and second swivels includes a fastening member configured to detachably connect at least one of the grip and the first and second tethers to the mainline.

3. The multi-pet leash according to claim 1, wherein
at least one of the grip, the mainline and the first and second tethers includes reflective nylon.

4. The multi-pet leash according to claim 3, wherein
the reflective nylon is designed as reflective webbing.

5. The multi-pet leash according to claim 1, wherein
at least one of the first and second tethers includes an elastic portion.

6. The multi-pet leash according to claim 1, wherein
at least one of the grip, the mainline and the first and second tethers is primarily formed from nylon.

7. The multi-pet leash according to claim 1 wherein,
at least the grip is padded.

8. The multi-pet leash according to claim 1, wherein
the grip is one of a first grip and a second grip, the second grip being a loop.

10. The multi-pet leash according to claim 9, wherein
the second grip includes the second mainline end of the mainline.

11. The multi-pet leash according to claim 9, wherein
the second grip is padded.

12. The multi-pet leash according to claim 1, wherein
the first swivel has a first part, a second part and a swivel part, the first part being configured to be connected to the grip end, the second part being configured to be connected to the first mainline end, the swivel part being configured to connect the first and second parts.

13. The multi-pet leash according to claim 1, wherein
the second swivel has a first part, a second part and a swivel part, the first part being configured to be connected to the second mainline end, the second part being configured to be connected to the first tether ends, the swivel part being configured to connect the first and second parts.

14. The multi-pet leash according to claim 13, wherein
one of the first and second parts of the second swivel is a loop, the other of the first and second parts of the second swivel is a snap hook.

15. The multi-pet leash according to claim 14, wherein
the second part of the second swivel is the snap hook.
